(19) United States
(12) Patent Application Publication
(10) Pub. No.: US 2018/0368315 A1
(43) Pub. Date: Dec. 27, 2018

(54) TRIMMER HEAD SYSTEM

(71) Applicant: MULTICRAFT VENTURES LLC, Pelahatchie, MS (US)

(72) Inventors: Paul Jones, Canton, MS (US); Charles D. Flumm, Brandon, MS (US); Tommy Nichols, Brandon, MS (US)

(73) Assignee: MULTICRAFT VENTURES LLC, Pelahatchie, MS (US)

(21) Appl. No.: 15/630,078

(22) Filed: Jun. 22, 2017

(51) Int. Cl. A01D 34/416; F16B 21/12; B25F 3/00; A01B 1/16; A01C 5/02

(52) U.S. Cl. CPC A01D 34/4165; F16B 21/125; A01C 5/02; A01B 1/16; B25F 3/00

(57) ABSTRACT

A method and device for increased efficiency of attachment of traditional accessories at the perimeter of a standard trimmer head via improved attachment means comprising a trimmer head having an upper portion and a lower portion, a cutting medium, and attachment means. The system further comprising an adapter plate for attaching custom accessories and commercially available, off the shelf rotary accessories at the center of the trimmer head, thus increasing the functionality of the trimmer head.

### FIELD OF THE INVENTION

The present invention is generally directed toward a trimmer head system. More particularly, the present invention relates to a system containing an adaptable trimmer head that accepts various custom and commercially available cutting mediums and rotary accessory devices.

### BACKGROUND OF THE INVENTION

Landscaping and maintenance of lawns and gardens is a tedious process requiring numerous tools which perform different functions. Weed trimmers are a common tool known in the art that use flexible line or a blade to cut grass and other vegetation near objects, or on a steep or irregular terrain. The current weed trimmer head devices allow for interchangeability of various traditional blade and line attachments at the perimeter of the trimmer head. Some of these trimmer head devices even allow for attachment of custom accessories, such as mixers or cultivators, which also attach at and rotate around the perimeter of the trimmer head. However, these accessories attach to standard trimmer heads via standard connection members, such as screws and bolts, requiring the user to take time and use additional tools to install the standard and custom accessories. Thus, a more efficient attachment of the traditional and custom accessories is needed in the art.

Additionally, these improved trimmer head devices do not allow for the attachment of commercially available, off the shelf rotary accessories, such as wire brushes and sanding disks, which must attach at the center of the trimmer head and may be useful to users performing home improvement and other maintenance tasks. Such a system would allow the user to exploit the long body of the trimmer head to prevent the need to bend over in the manner normally required for use of off the shelf rotary accessories and decrease the time it takes a user to perform various tasks. Therefore, a system capable of performing a variety of functions, not limited to landscaping, utilizing the body of a trimmer head is needed.

### SUMMARY OF THE INVENTION

Trimmer head systems are functional for cutting vegetation with blades and lines, and in rare instances, custom accessories may be attached to accomplish additional tasks, such as mixing and cultivating. These various accessories are not easily interchangeable and require attachment at the perimeter of the housing of the trimmer head via customization in some instances. The presently disclosed invention is a method and system device comprising an interchangeable trimmer head with adapter plate. The trimmer head allows for both custom and commercially available cutting mediums, such as traditional weed trimmer line and plastic blades or metal reinforced blades. The cutting medium can be quickly and efficiently interchanged via improved attachment means. The adapter plate allows for attachment of both custom and commercially available, off the shelf rotary accessories. Commercially available rotary accessories are attached to the trimmer head via a separate adapter plate, while custom accessories attach to an adapter plate feature incorporated into the trimmer head. This system allows for increased efficiency of attachment of traditional and custom mediums at the perimeter of the trimmer head via improved attachment means and the ability to attach custom and commercially available, off the shelf rotary accessories at the center of the trimmer head.

### BRIEF DESCRIPTION OF THE DRAWINGS

Further advantages of the invention will become apparent by reference to the detailed description of preferred embodiments when considered in conjunction with the drawings:

FIG. 1 depicts a perspective view of the base of the trimmer head assembly.

FIG. 2 depicts a perspective view of the base of the trimmer head assembly with a non-hex drive shaft.

FIG. 3 depicts a perspective view of the base of the trimmer head assembly with a hex drive shaft.

FIG. 4 depicts a perspective view of the base of the trimmer head with line.

FIG. 5 depicts a perspective view of a holder piece with line.

FIG. 6 depicts a perspective view of an embodiment of a custom cutting medium using traditional trimmer line.

FIG. 7 depicts a perspective view of the trimmer head assembly with a blade.

FIG. 8 depicts a perspective view of the adapter plate.

FIG. 9 depicts a rear elevational view of the adapter plate.

FIG. 10 depicts a perspective view of the trimmer head with adapter plate and clips.

FIG. 11 depicts a bottom elevational view of an embodiment of the adapter plate.

FIG. 12 depicts a perspective view of a clip.

FIG. 13 depicts a perspective view of a mounting pin and clip.

FIG. 14 depicts a perspective view of the trimmer head assembly with adapter plate and custom accessory installed.

FIG. 15 depicts an embodiment of a custom accessory.

FIG. 16 depicts a perspective view of trimmer head with adapter plate and rotary accessory installed.

FIG. 17 depicts a perspective view of commercially available rotary accessories.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

The present invention is a trimmer head system for attaching traditional line 21 and blades 22 via improved attachment means 12 and custom 57 and commercially available off the shelf rotary accessories 44 to a traditional trimmer head 11 using an adapter plate 13 when necessary. The attachment means 12 solve the problem of inefficient attachment of standard and custom accessories 57 by allowing the user to seamlessly attach the accessories around the perimeter 35 of the trimmer head 11 without using separate tools or spending excessive time.

The system also contemplates an adapter plate 13 for attachment of both custom 57 and commercially available rotary accessories 44 at the center 45 of the trimmer head 11. For commercially available rotary accessories 44, the adapter plate 13 attaches to the lower portion 16 of the housing of the standard trimmer head 11 via mounting pins 43 secured by improved spring clips 34, as shown in FIG. 13. For custom accessories 57, the adapter plate 13 is a component of the improved trimmer head 11, so the custom accessory 57 is attached directly to the trimmer head 11.

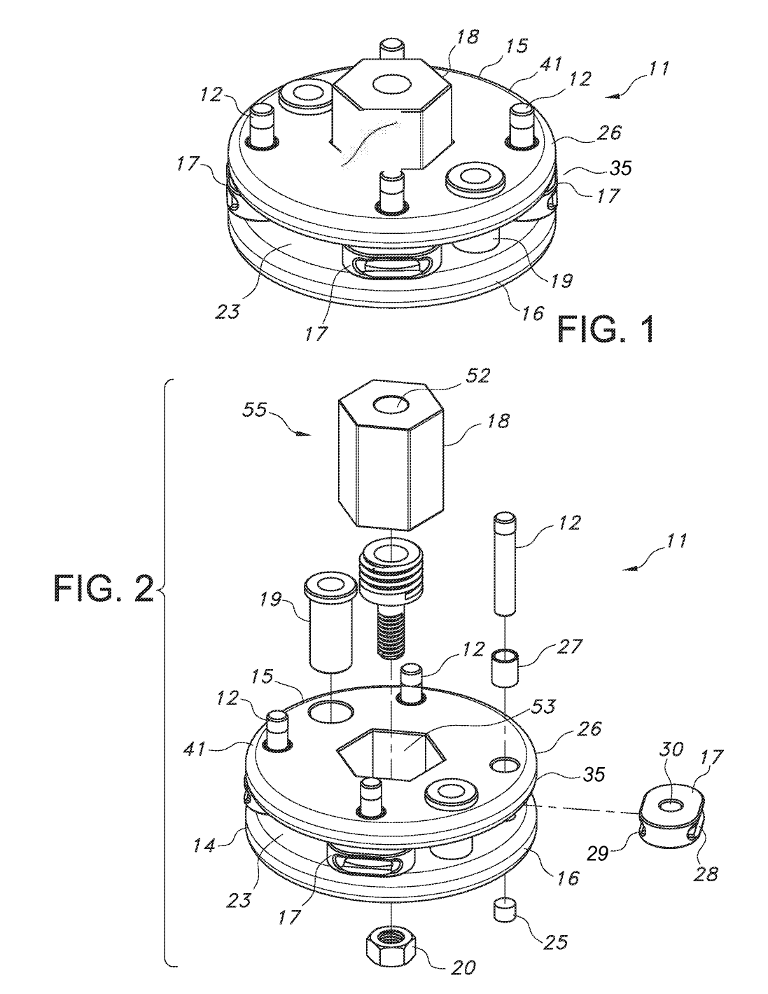

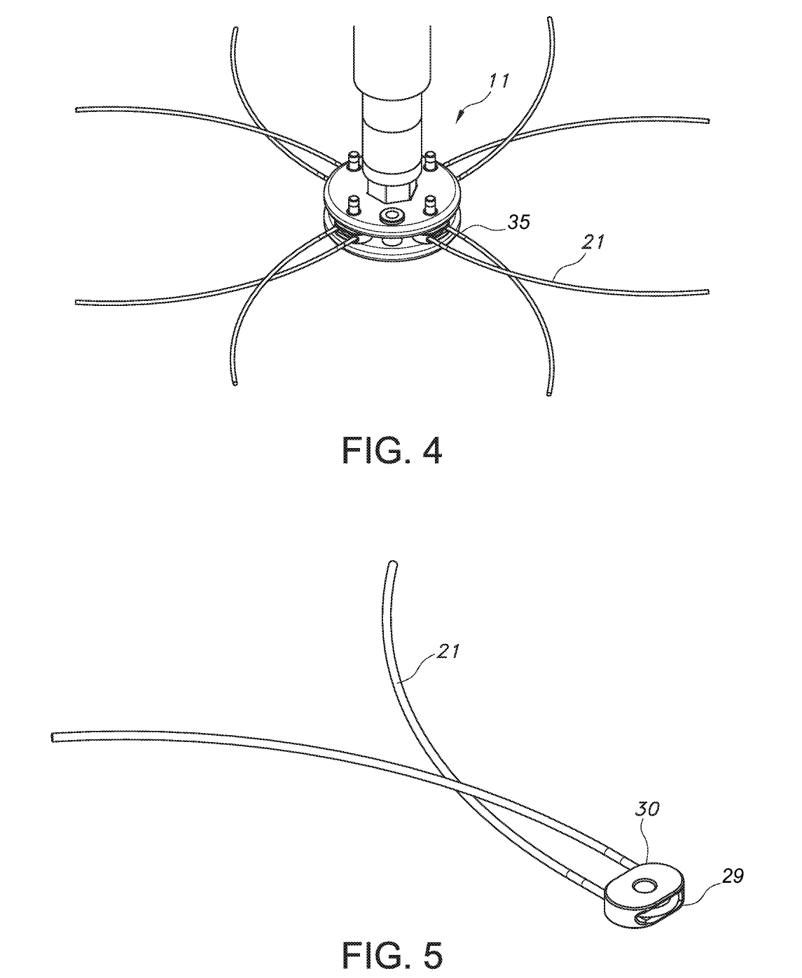

The trimmer head system as shown in FIG. 1 and FIG. 2 consists of a traditional trimmer head 11, attachment means 12, and an accessory adapter plate 13 to attach commercially available, off the shelf rotary accessories 44. The proposed trimmer head 11 is an interchangeable device which can replace and fit on multiple types of models and trimmer units on the market. Once the user removes the standard trimmer head, the improved trimmer head 11 can be installed using various hardware supplied with the trimmer head 11. As shown in FIG. 1, the trimmer head 11 is comprised of a circular housing 14, holder pieces 17, and various bolts 19 and nuts 20 to allow the user to attach various standard weed trimmer lines 21 (as shown in FIGS. 4, 5, and 6) and plastic or metal blades 22 to the trimmer head 11, as shown in FIG. 7.

As shown in FIG. 2, the housing 14 of the trimmer head 11 is a single component comprised of an upper portion 15 and lower portion 16 with a recessed area 23 between the upper portion 15 and lower portion 16 of the housing 14. The upper portion 15 of the housing 14 is attached to the drive shaft of a trimmer system and turns with the drive shaft, causing the entire housing 14 to rotate when the trimmer system is in operation.

There are two standard types of trimmers with different drive shaft attachment mechanisms. After removing the original standard trimmer head, the improved trimmer head 11 is attached to the drive shaft of the trimmer body based on which type of drive shaft is present. As shown in FIG. 2, the first type (Adapter Stem style 1) is a non-hex 55 drive shaft, which is a solid, threaded shaft coming from the trimmer. An elongated nut 52, provided with the trimmer head replacement kit, is placed inside the Adapter Stem style 1 recessed hex pocket 53 on the inside of the trimmer head housing 14 as further described below. The Adapter Stem is then inserted onto the threaded shaft of the weed trimmer and locked in place with the nut 52. The trimmer head 11 is then installed using the threaded bolt 24 to connect the Adapter stem to the housing 14 of the trimmer head 11.

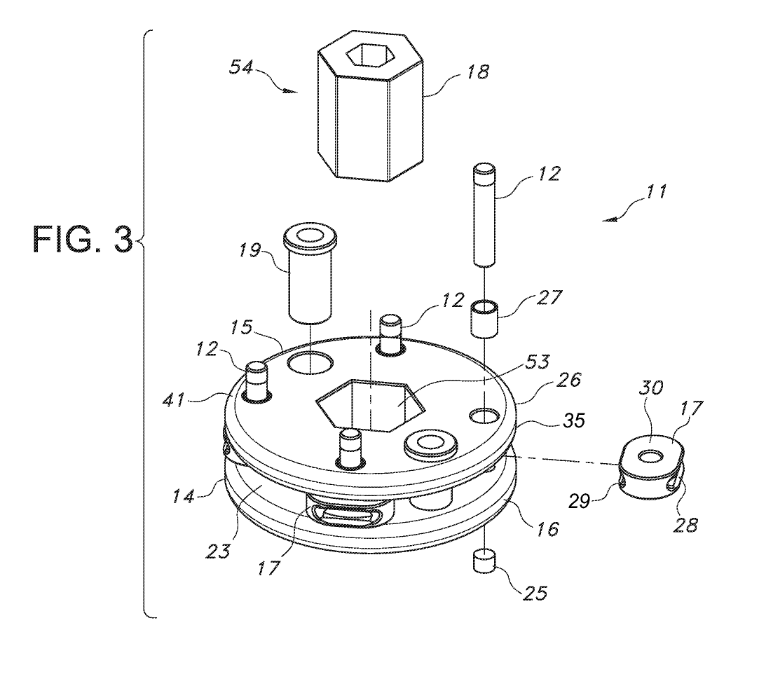

The second type (Adapter Stem style 2) has a hex 54 drive shaft, which is a hollow internally threaded shaft coming from the trimmer, with a hex nut 18 at top of the shaft, as shown in FIG. 3. The threaded bolt 24 is not required for connection. Instead, the internally threaded 54 drive shaft with hex nut 18 atop of the shaft is inserted through the Adapter Stem style 2 and through the trimmer body and then secured using a bolt 19 at the bottom.

Various size nuts and spacers are contemplated to accommodate different length shafts and thread size attached via one of the two methods discussed above.

In the preferred embodiment of the system, when mounting standard trim line 21 or cutting mediums 22, magnetic pins 12 are used to secure the holding piece 17 for the line 21 or other cutting medium 22 in place, as shown in FIGS. 4-5. As shown in FIG. 2, the magnetic pins 12 extend perpendicular to the housing 14 through pin holes 26 and are held magnetically by a magnet 25 which is pressed into the pin hole 26 which extends through the lower portion 16 of the housing 14. To attach a cutting medium 22, the user lifts the pin 12 from the magnet 25 and inserts either the holder piece 17 or other cutting mediums 22.

In addition to the magnetic pins 12, bushings 27 can be inserted into the pin holes 26 to increase durability at pin attachment locations 41. The system also contemplates other attachment means 12 capable of efficiently attaching standard accessories at the perimeter 35 of a trimmer head 11, such as quick acting couplings and other quick connect mechanisms.

For mounting traditional trim line 21, holder pieces 17 are mounted on at least one magnetic pin 12 within the recessed area 23 free to rotate around a magnetic pin 12. Each holder piece 12 consists of an elongated lobe defining a central, axial opening 30 for receiving a magnetic pin 12, defining two channels 28 extending through the holder piece 17, and an open edge groove 29 circumferentially extending to one of the two defined channels 28. The parallel channels 28 run in a plane that is perpendicular to the longitudinal axis of the central opening 30. The magnetic pin 12 extends through said central opening 30 enabling the holder piece 17 to rotate about the magnetic pin 12.

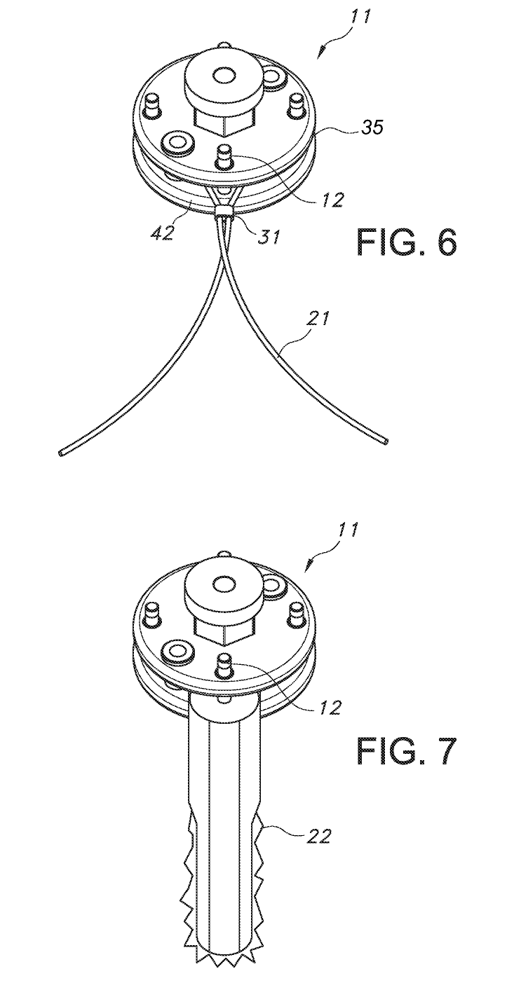

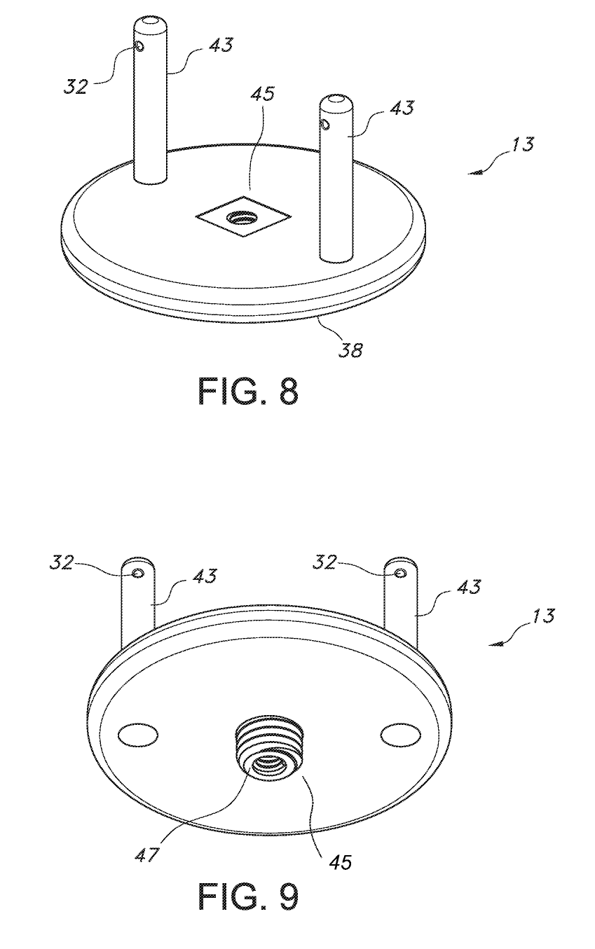

When the holder pieces 17 are not used for traditional line 21 attachment, a loop 31 may be formed at the end of the trim via a connection piece 42 securing the two ends of the trimmer line 21 together, as depicted in FIG. 6. The loop 31 is inserted and held in place by the magnetic pin 12.

The housing 14 and holding pieces 17 can be made of any material capable of accomplishing the necessary functions, including, without limitation, plastic or metal.

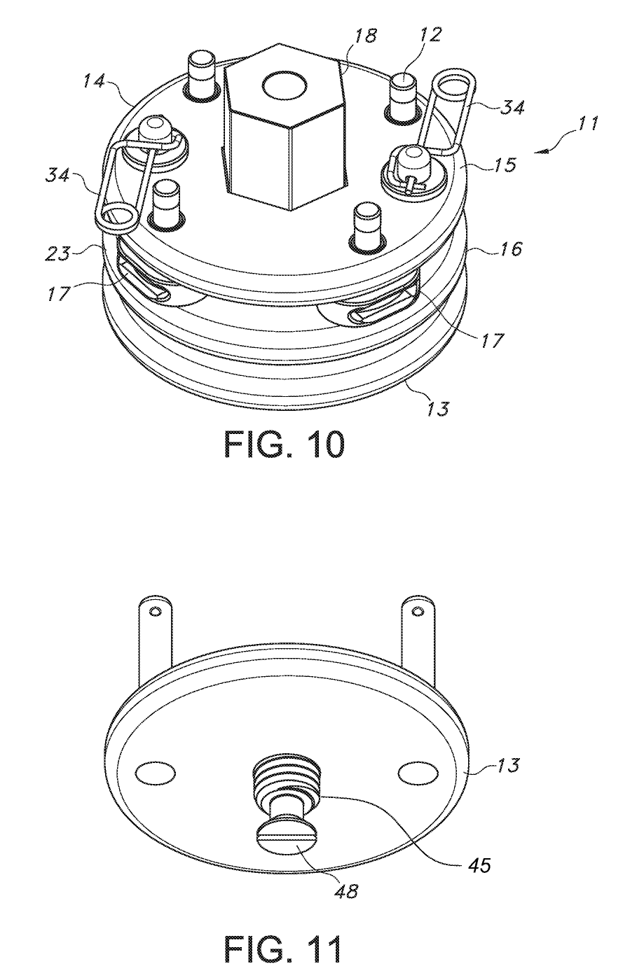

In the preferred embodiment of the invention, to attach commercially available, off the shelf rotary accessories 44 to the center 45 of the trimmer head system, an adapter plate 13 is mounted to the lower portion 16 of the trimmer head housing 14 via two mounting pins 43 containing clip holes 32 in the top ends 33 located opposite the adapter plate 13 which extend through the lower portion 16 and upper portion 15 of the trimmer head housing 14, as shown in FIG. 7. Once extended through the housing 14, spring clips 34 are inserted through the clip holes 32 perpendicular to mounting pins 43 to secure the mounting pins 43 above the upper portion 15 of the housing 14, as shown in FIG. 10. The prior art only allows for attachment of custom accessories along the perimeter 35 of the trimmer head 11, thus limiting the types of accessories which may be attached and overall function of the trimmer head system.

While the adapter plate 13 in the preferred embodiment of the system contains two mounting pins 43, any number of mounting pins 43 may be utilized to attach the adapter plate 13 to the trimmer head 11.

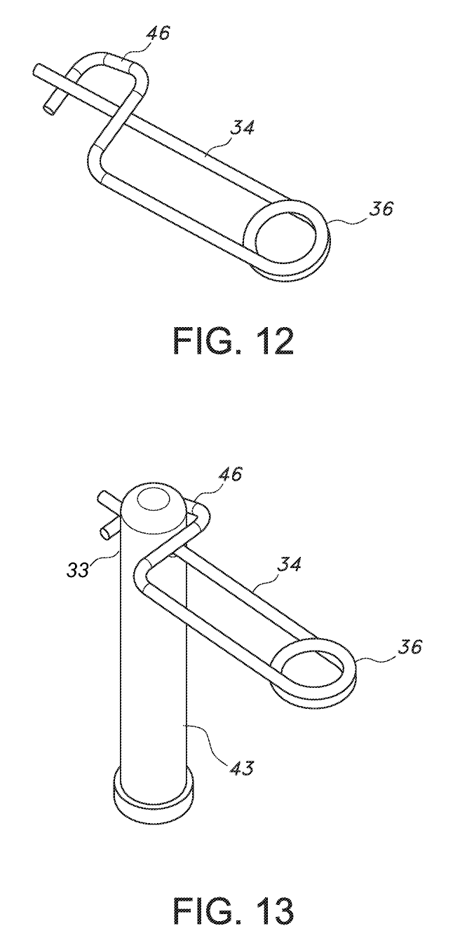

Standard clips 34 can sling off during high RPM. Thus, as shown in FIGS. 12-13, the preferred embodiment of the clip 34 pinches and threads the straight portion 36 through the clip hole 32 in the mounting pin 43, and then release clip 34 resulting in the hook feature 46 locking behind the pin 43 and under the straight portion 36 of the clip 34.

The adapter plate 13 provides two mounting options for custom and off the shelf rotary accessories 44. The accessory may contain a center hole 38 and screw directly onto the external threads 47 of the adapter plate 13 or may be placed over the threaded bolt 47 and secured with a nut built into the accessory. Depending on the model, some weed trimmers turn clockwise and some turn counterclockwise. On clockwise versions, any accessory threaded on the adapter plate 13 will self-tighten during use. On counterclockwise versions, the accessory will try to unscrew. In either case, a left handed screw 48 is mounted into the bolt 47 with internal thread to ensure the accessory is firmly attached and does not come off during counter clockwise or clockwise rotation of the trimmer system, as shown in FIG. 11.

For custom accessories 57, a long rod 37 protrudes through the central hole of 38 the adapter plate 13 away from the trimmer head 11. The long rod 37 is designed to allow multiple types of custom accessories 57 to be installed onto the rod 37. Center 45 attachment of the custom accessory 57 to the long rod 37 may be accomplished in numerous ways but the preferred embodiment incorporates a flat area 49 on the rod 37 with a corresponding flat 50 designed into the accessory. A set screw 51 is then inserted to secure the accessory to the long rod 37.

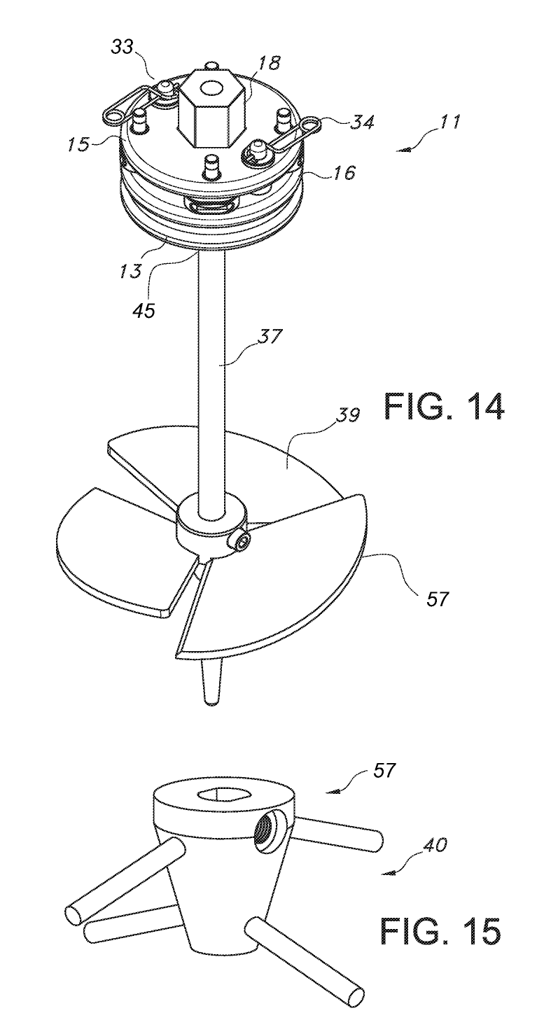

The custom accessories 57 which may be attached to the long rod 37 include, but are not limited to, a planter device 39, weed pullers 40, mixer blades, trenching devices, weed pullers 40, and surface cultivators. These custom accessories 57 can be designed as one unit or allow for one adapter plate 13 and long rod 37 with multiple components installed as shown in FIG. 14, discussed below.

The planter device 39 contemplated herein is a custom accessory 57 which digs 6″ holes. Other size holes are also contemplated by the custom planter device 39 accessory. In FIG. 14, the planter device 39 is shown attached to the drive shaft of the trimmer head 11 as a separate removable piece. Additionally, other separate accessory pieces could be swapped for different functions, such as the weed puller 40 shown in FIG. 15.

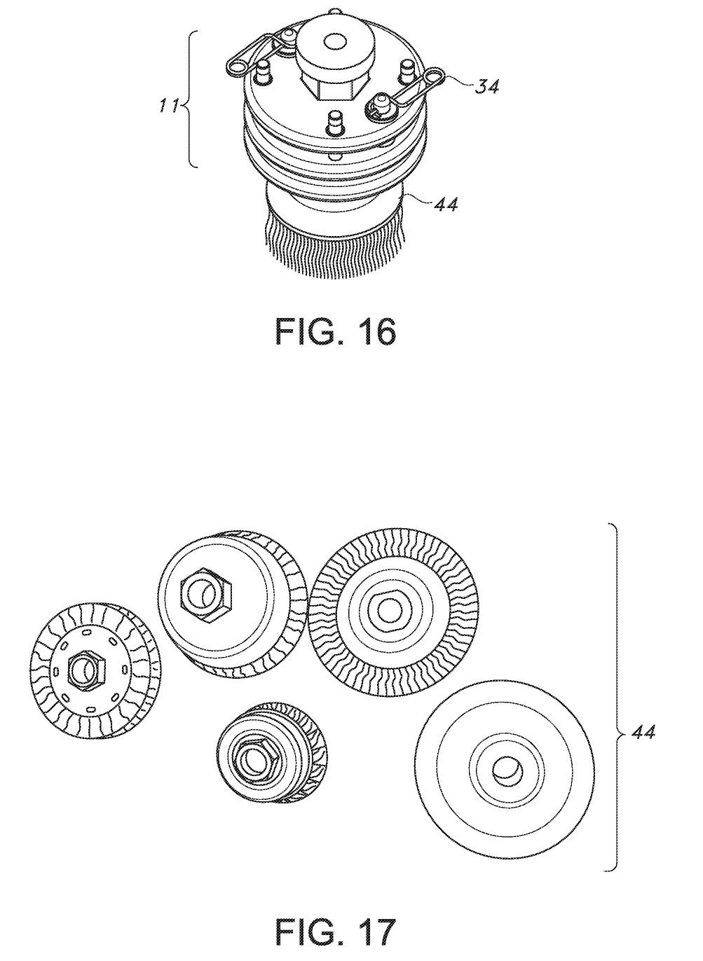

While the prior art requires additional custom accessories to attach various rotary accessories 44 to the perimeter 35 of the trimmer head 11, the easy attachment of the adapter plate 13 to the trimmer head 11 via mounting pins 43 secured by spring clips 34 allows for center 45 attachment of commercially available, off the shelf rotary accessories 44, as shown in FIG. 16. For example, a user could first use the trimmer head 11 with standard blade 22 to cut vegetation which has overgrown stone landscaping, then attach the adapter plate 13 and grind and buff the stone all while using the trimmer head system.

These rotary accessories 44 which may be attached to the center 45 of the trimmer head 11 via the adapter plate 13 include, without limitation, a cut off wheel, wire brush, sanding disk, buffer pad, grinder pad, etc. An example of these accessories is depicted in FIG. 16 and includes any rotary accessory which may be attached at the center 45 of the trimmer head 11 via the adapter plate 13. Unlike the prior art, the efficient attachment of rotary accessories 44, such as sanding disks and buffer pads, to the interchangeable trimmer head 11 provides the user the ability to utilize a standard trimmer head 11 to accomplish more and varying tasks in an efficient manner.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

We claim:

1. A trimmer system for attaching standard trimmer lines and cutting mediums comprising:
a. a trimmer head, wherein said trimmer head further comprises a housing having an upper portion and a lower portion;
b. a cutting medium; and
c. attachment means, wherein said attachment means connect the cutting medium to said trimmer head.

2. The cutting mediums of claim 1 wherein said cutting medium is trimmer line.

3. The trimmer line of claim 2 wherein said trimmer line is connected to the trimmer head via a holder piece.

4. The cutting medium of claim 2 wherein said trimmer line is connected to the trimmer head via a loop and custom connection piece configured to secure the two ends of the trimmer line together.

5. The cutting medium of claim 1 wherein said cutting medium is a blade.

6. The trimmer head of claim 1 wherein said trimmer head is configured to replace original trimmer heads.

7. The attachment means of claim 1 wherein said attachment means is magnetic pins.

8. A trimmer system for attaching rotary accessories comprising:
a. a trimmer head, wherein said trimmer head further comprises a housing having an upper portion and a lower portion;
b. a connection mechanism for securing said trimmer head to the rotary accessories;
c. an adapter plate capable of attaching to the trimmer head and receiving rotary accessories; and
d. rotary accessories, wherein said rotary accessories are attached to the trimmer head via the adapter plate.

9. The rotary accessories of claim 7 wherein said accessories are commercially available off the shelf.

10. The connection mechanism of claim 7 wherein said connection mechanism is a clip and mounting pins.

11. The clips of claim 9 wherein said clips are standard spring clips.

12. The clips of claim 9 wherein said clips are custom spring clips with a locking mechanism behind the pin to secure the trimmer head to the accessory.

13. A method for attaching commercially available rotary accessories to a weed trimmer comprising:
a. replacing an original trimmer head with a trimmer head capable of receiving an adapter plate;
b. attaching the adapter plate to the lower portion of the housing of the trimmer head via a connection mechanism; and
c. connecting a rotary accessory to the trimmer head via the adapter plate.

14. The rotary device of claim 13 wherein said rotary accessory is a cut off wheel.

15. The rotary device of claim 13 wherein said rotary accessory is a wire brush.

16. The rotary device of claim 13 wherein said rotary accessory is a sanding disk.

17. The rotary device of claim 13 wherein said rotary accessory is a buffer pad.

18. The rotary device of claim 13 wherein said rotary accessory is a cut off wheel.

19. A trimmer system for attaching custom accessories comprising:
a. a trimmer head, wherein said trimmer head further comprises a housing having an upper portion and a lower portion and an adapter plate;
b. a connection mechanism for securing said trimmer head to the custom accessories; and
c. custom accessories, wherein said custom accessories are attached to the adapter plate at the center of the trimmer head.
